(19) United States
(12) Patent Application Publication
(10) Pub. No.: US 2025/0030205 A1
(43) Pub. Date: Jan. 23, 2025

(54) ELECTRICAL CONNECTOR WITH AN IMPROVED GROUNDING MEMBER

(71) Applicants: FUDING PRECISION INDUSTRY (ZHENGZHOU) CO.,LTD., Zhengzhou (CN); FOXCONN INTERCONNECT TECHNOLOGY LIMITED, Grand Cayman (KY)

(72) Inventor: Meng Liu, Kunshan (CN)

(21) Appl. No.: 18/778,332

(22) Filed: Jul. 19, 2024

(30) Foreign Application Priority Data
Jul. 22, 2023 (CN) 202310917510.4
Jul. 22, 2023 (CN) 202321966272.8

(51) Int. Cl. H01R 13/6597; H01R 12/73; H01R 13/6594

(52) U.S. Cl. CPC H01R 13/6597; H01R 12/737; H01R 13/6594

(57) ABSTRACT

An electrical connector includes: an insulating housing having two side walls and a longitudinal mating slot between the two side walls; a row of terminals located at the side wall and comprising plural pairs of signal terminals and plural grounding terminals in a longitudinal direction, each terminal including an elastic arm with a contacting portion, a tail portion and a middle fixing portion between the elastic arm and the tail portion; and a grounding member located between the side wall and the row of the terminals and extending in the longitudinal direction, wherein the grounding member includes plural grounding portions extending inwards and contacting corresponding grounding terminals and plural attached portions extending outwards, and the attached portions are aligned with corresponding grounding portions in a transverse direction perpendicular to the side walls.

### BACKGROUND OF THE INVENTION

### Field of the Invention

The present invention relates to an electrical connector with an improved grounding member.

### Description of Related Arts

China Patent No. 207572652 discloses an electrical connector which comprises an insulating housing with a mating slot, two rows of terminals, and a grounding member between the two rows of grounding member. Each row of terminals comprise a plurality of grounding terminals and pairs of signal terminals. The grounding member has plural shielding portions facing corresponding pairs of signal terminals and grounding fingers contacting with corresponding grounding terminals. A height of the shielding portion is limited as an upper part of an elastic arm of the terminal bends inwardly into the mating slot. In addition, the grounding fingers has little contacting face with corresponding grounding terminal.

The requirement for the transmission rate of electrical connectors is getting higher and higher. A transmission bandwidth of some connectors has even reached 128 Gbps. The grounding member may no longer meet the transmission rate for a better high-frequency performance.

Therefore, it is necessary to provide an electrical connector with an improved grounding member to overcome the above defects.

### SUMMARY OF THE INVENTION

The object of the present invention is to provide an electrical connector with an improved grounding member.

To achieve the above object, an electrical connector comprises: an insulating housing having two side walls and a longitudinal mating slot between the two side walls; a row of terminals located at the side wall and comprising plural pairs of signal terminals and plural grounding terminals in a longitudinal direction, each terminal comprising an elastic arm with a contacting portion, a tail portion and a middle fixing portion between the elastic arm and the tail portion; and a grounding member located between the side wall and the row of the terminals and extending in the longitudinal direction, wherein the grounding member comprises plural grounding portions extending inwards and contacting corresponding grounding terminals and plural attached portions extending outwards, and the attached portions are aligned with corresponding grounding portions in a transverse direction perpendicular to the side walls.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of an embodiment of this present invention;

FIG. 2 is a cross-sectional view of the electrical connector along line A-A in FIG. 1;

FIG. 3 is a cross-sectional view of the electrical connector along line B-B in FIG. 1;

FIG. 4 is an exploded perspective view of the electrical connector of FIG. 1;

FIG. 5 is a further exploded perspective view of the electrical connector of FIG. 4, wherein an out shell is removed;

FIG. 6 is another perspective view of the electrical connector of FIG. 5;

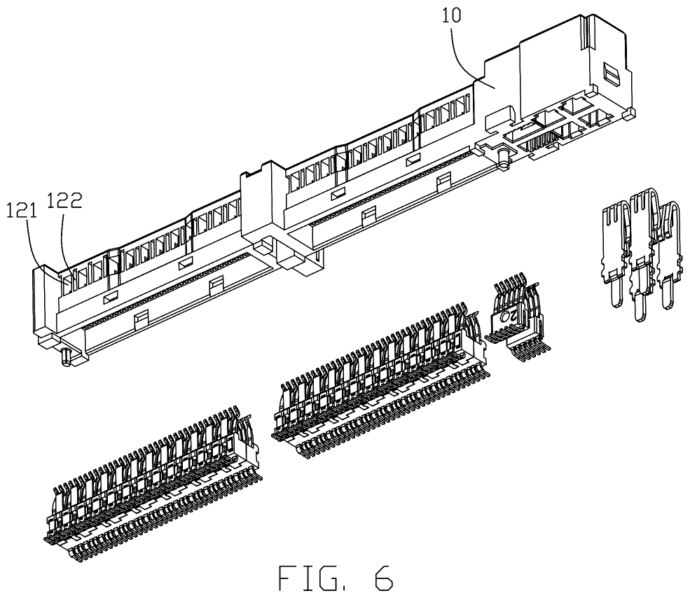

FIG. 7 is an exploded perspective view of a pair of terminal modules with signal terminals and grounding terminals of FIG. 6;

FIG. 8 is a further exploded perspective view of one terminal module of FIG. 7;

FIG. 9 is a further exploded perspective view of the terminal module of FIG. 8;

FIG. 10 is a left partial front view of the electrical connector without the out shell in FIG. 4;

FIG. 11 is a partial front view of a row of terminals with a grounding member located at one side of the row of terminals;

FIG. 12 is a perspective view of the row of terminals of FIG. 11; and

FIG. 13 is a partial perspective view of one terminal module.

### DETAILED DESCRIPTION OF THE PREFERRED EMBODIMENT

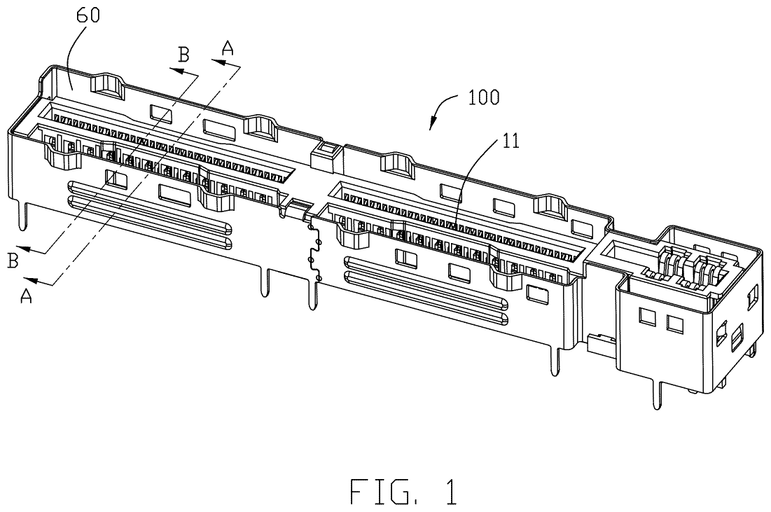

Referring to FIGS. 1-3, an electrical connector 100 is illustrated. The electrical connector 100 is adapted for being fixed on a circuit board, that is a board connector. The electrical connector 100 can mate with a mating connector, such as a cable connector (not shown) or a paddle card.

Referring to FIGS. 1 and 8-9, the electrical connector 100 comprises a longitudinal insulating housing 10, at least one row of terminals 20 and at least one grounding member 30. In this embodiment, the insulating housing 10 has three mating slots 11, the left two of the mating slots 11 are signal mating slots, and the right one is power mating slot. Alternatively, in other embodiments, the electrical connector 100 may have more than three mating slots 11 or less mating slots. The insulating housing 10 has two side walls 12 or long walls defining the longitudinal mating slot 11 between the two side walls 12. A row of terminals 20 are fixed in an insulator 40 form a terminal module. The terminal module is assembled and fixed to the insulating housing and located at corresponding side wall of the mating slots 11. The row of terminals 20 in the signal mating slot 11 comprise plural pairs of signal terminals 20S and plural grounding terminals 20G between adjacent two pairs of the signal terminals 20S in the longitudinal direction. In this embodiment, two terminal modules are assembled and then inserted and retained in the insulating housing 10.

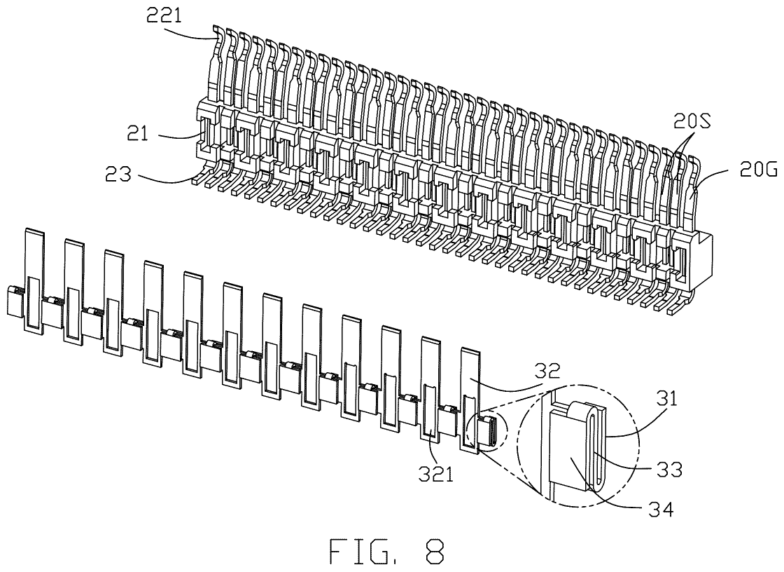

Referring to FIGS. 1-3, each terminal 20 in the signal mating slot 11 comprises a fixing portion 21 fixed in the insulator 40, an elastic arm 22 and a tail portion 23 extending out of the insulator 40. The elastic arm has an arc contacting portion 221 at an upper free end thereof. The contacting portion 221 protrudes into the mating slot 11. In this embodiment, a grounding member 30 is fixed to the insulator 40 and is located at an outside of corresponding row of terminals 20. The grounding member 30 comprises plural grounding portions 31 and shielding portions 32, the grounding portions 31 contact corresponding grounding terminals 20G, and the shielding portions 32 face and shield corresponding pairs of signal terminals 20S. The shielding portions 32 extend in an upright direction for better shielding of the pair of the signal terminals 20S. Two adjacent shielding portions 32 are connected with a bridge portion 33. An attachment portion 34 and the grounding portion 31 are located at two sides of the bridge portion 33 respectively. The attachment portion 34 bends outwardly from an upper end of the bridge portion 33 and then extends downward vertically, and the grounding portion 31 bends inwardly from a lower end of the bridge portion 33 and then extends upward vertically. Therefore, the attached portion 34, and the bridge portion 33 and the grounding portion 31 are parallel to each other and construct an S shape wholly. Alternatively, the attachment portion 34 may bend outwardly from the lower end of the bridge portion 33 while the grounding portion bends downwardly from the upper end of the bridge portion 33. It's clearly shown in FIG. 8, the distance of the S shape in the transverse direction is enlarged, so as to increase the electric performance of the connector. The attached portions 34 can be disposed to abut against the side walls 12.

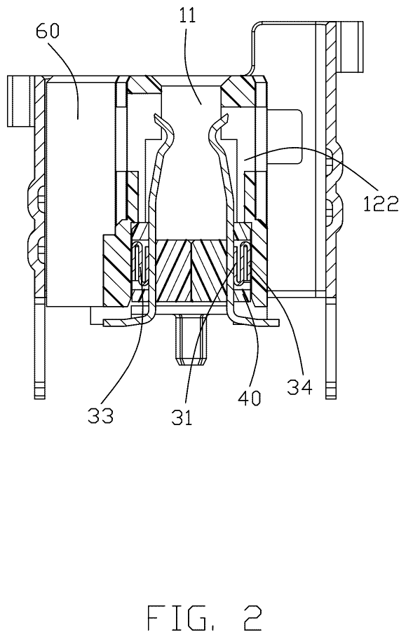

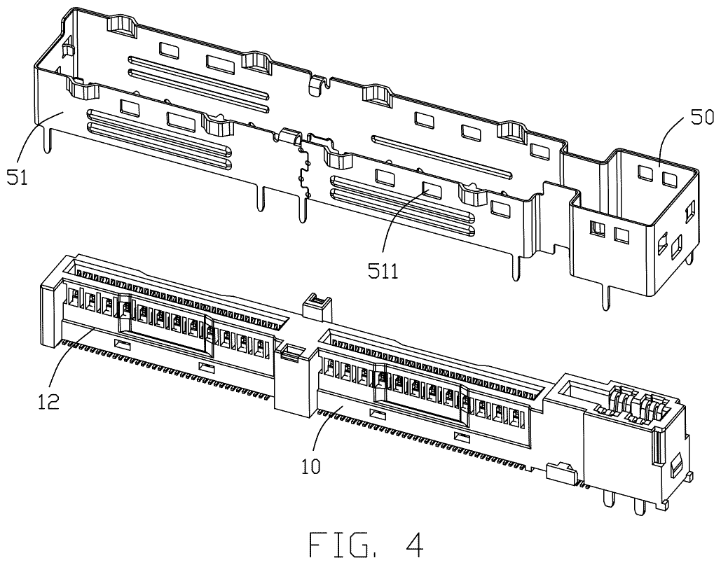

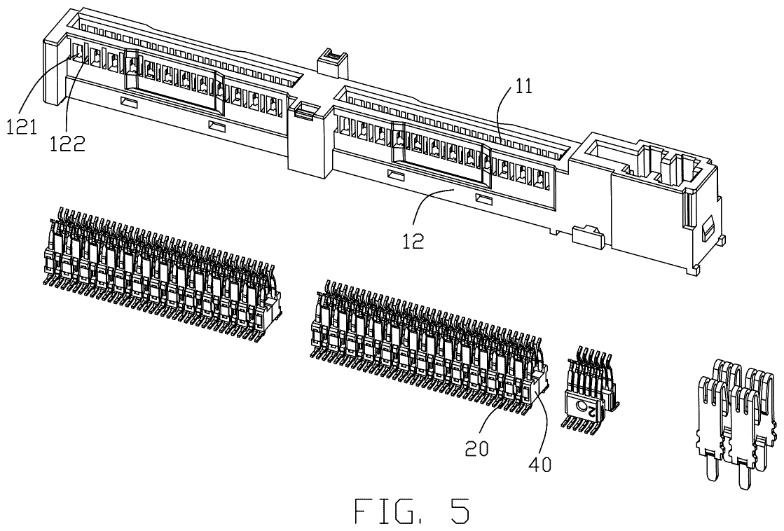

Referring to FIGS. 1-4, the electrical connector 100 comprises an metallic shell 50 surrounding an outside of the insulating housing 10, the shell 50 comprises two side plates 51 facing corresponding side walls 12. The side plate 51 and corresponding side wall 12 are spaced apart from each other and a mating groove 60 is defined therebetween, the mating groove 60 is parallel to the mating slot 11. Each side plate 51 has at least two locking holes 511. The side wall 12 of the insulating housing 10 has plural first slots 121 facing contacting portions of corresponding pairs of signal terminals 20S and plural second slots 122 facing corresponding contacting portions of grounding terminals 20G. The first slots 121 and the second slots 122 are located at a similarly level with the contacting portions 221 of the terminals 20 The two contacting portions 221S of the pair of signal terminals 20S expose to corresponding first slot 121 and the contacting portion 221G of one grounding terminal is exposed to the second slot 122 as best shown in FIGS. 2-3 and FIG. 5. As the insulating material around the contacting portions of the terminals are decreased by the first slots and the second slots, more room for the movement of the contacting portions of the terminals are provided and thus, the resistance of the terminals are improved. The pair of signal terminals is located in one first slot 121 to ensure the two signal terminals of the same pair in a same electrical property. The shielding portion 32 extend upward proximate to the contacting portions and exposes to the first slot 121, to shield more portions of the signal terminals.

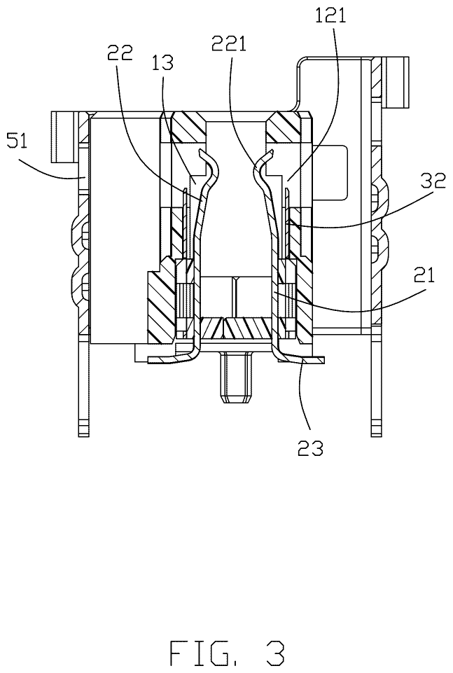

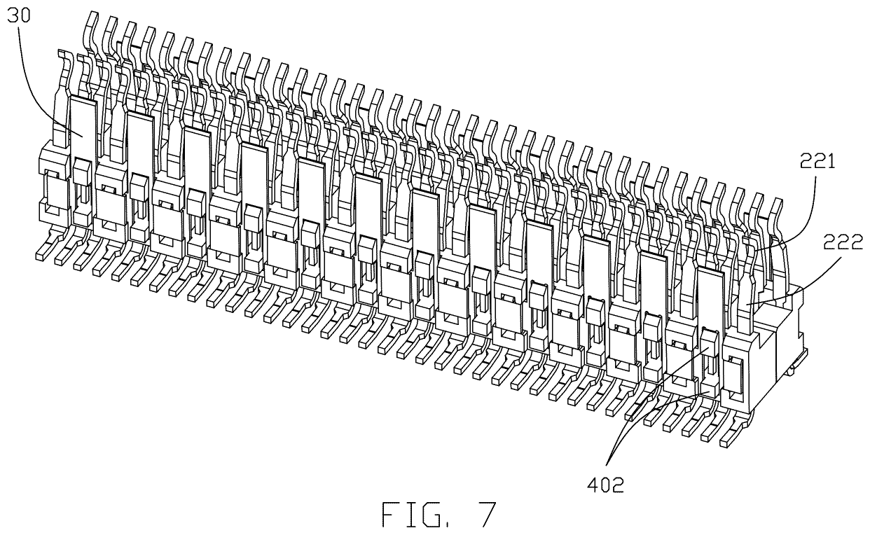

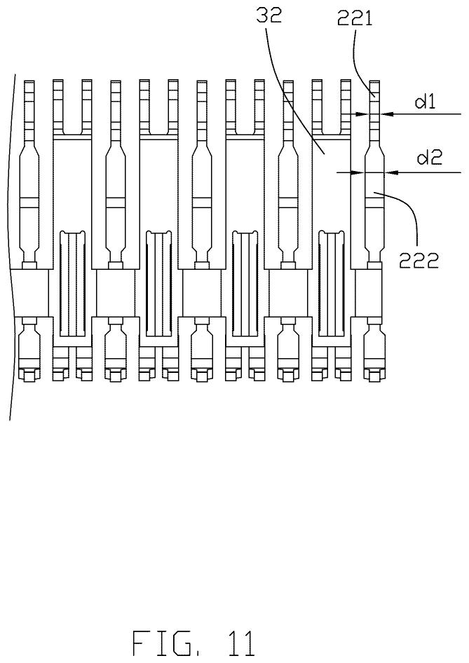

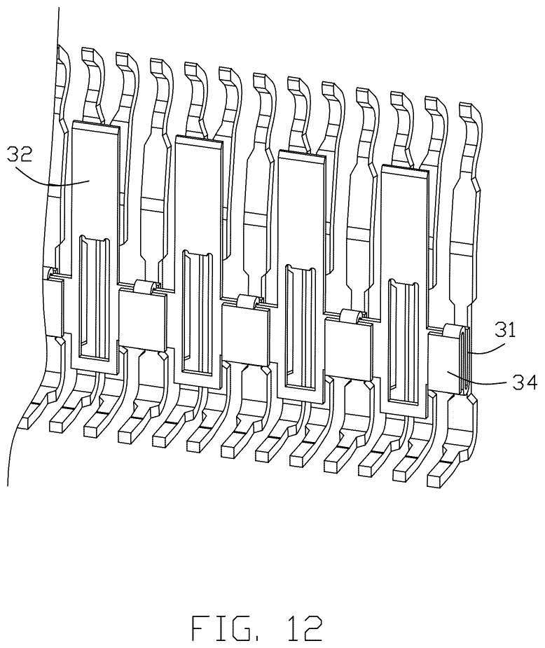

Referring to FIGS. 3, 7, and 11-12, two terminal modules are fixed together by locking portions of the insulators 40. The elastic arm 22 comprises an elastic portion 222 between the contacting portion 221 and the fixing portion 21, a width d1 of the elastic portion 222 is wider than a width d2 of the contacting portion 221. The shielding portions 32 extends upward and exceeds a lower edge of the contact portion 221, that is, the shielding portions 32 extends upward and exceeds a junction of the contacting portion 221 and the elastic portion 222. In other embodiment, an upper edge of the shielding portion 32 is at a similarly level as the lower edge of the contacting portion 221 of the signal terminals 20S, that is, the upper edge of the shielding portion 32 is substantially aligned with the lower edge of the contact portion 221 or the upper edge of the shielding portion 32 is substantially aligned with the junction of the contacting portion 221 and the elastic portion 222 of the signal terminals 20S.

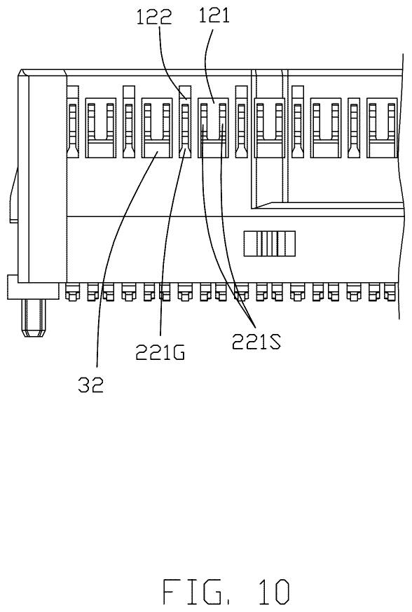

Combined with FIGS. 2-3 and 10, the side wall 12 has plural terminal grooves 13 in which the terminals 20 are received and retained. The first slot 121 and the second slot 122 penetrate the side wall 12 along a transverse direction perpendicular to the side wall 12, making pairs of signal terminals 20S expose to the first slot 121 and grounding terminals 20G are exposed to the second slot 122. Upper frame edges of the first slot 121 and the second slot 122 are located above the contacting portions 221, and the lower frame edge of the first slot 121 and the second slot 122 are located below the contacting portions 221, so both the contacting portions 221 and part of the elastic portions 222 are exposed to the first slots 121 and the second slots 122.

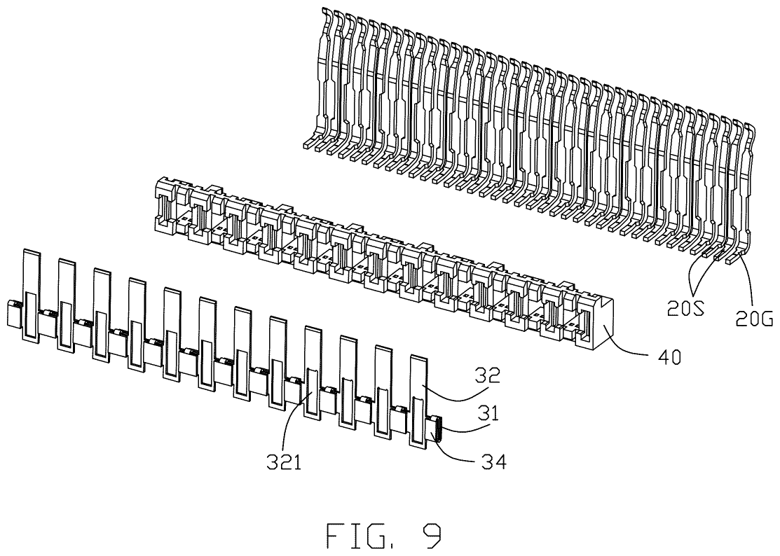

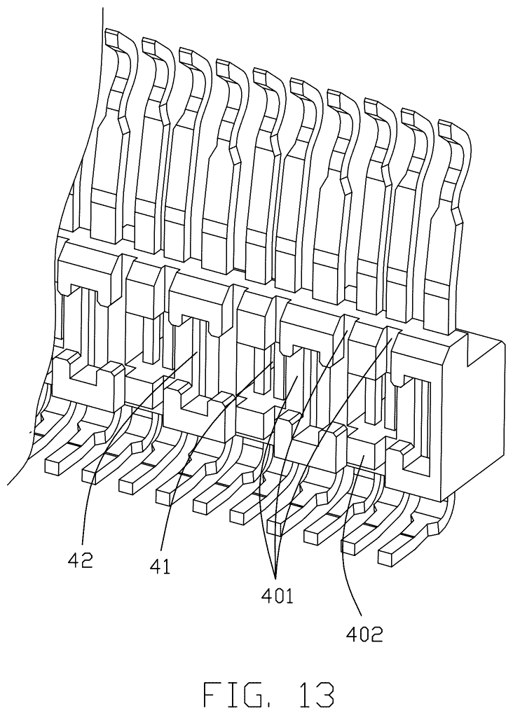

Referring to FIGS. 9 and 12-13, each shielding portion 32 has a vertical slot 321 which penetrates both sides thereof, the insulator 40 has plural receiving grooves 401 recessed inward from an outside thereof and plural convex portions 402 bulging relative to the receiving grooves 401. The grounding member 30 is assembled to the insulator 40 from an outside of the insulator 40 and is received in the receiving grooves 401, that is, the receiving grooves 401 includes a longitudinal receiving grooves receiving the grounding portions and lower portions of the shielding portions 32 and plural upright receiving grooves in which upper portions of the shielding portions 32 received. The convex portions 402 facing the shielding portion 32 go through and are received in the vertical slots 321. The convex portions 402 are interfered with the vertical slots 321. A first notch 41 goes through the convex portions 402 received in the vertical slot in the transverse direction, and thus, pairs of signal terminals 20S exposed to corresponding first notches 41. A second notch 42 goes through the insulator 40 in the transverse direction, that is, the second notch 42 goes through the receiving groove where the grounding portion 31 is received so that the corresponding grounding portion 31 goes across the second notch 42 to contact with corresponding grounding terminal 21G. An outside face of the attached portion 34 is substantially flush with the outside of the insulator 40. In this embodiment, the terminal module at another side of the mating slot 11 also has the grounding member 30, that is, both the two terminal modules located at two sides of the mating slot 11 have the grounding members 30.

In other embodiment, the grounding member 30 with the bridge portion 33, the attached portion 34 and the grounding portion 31 may be placed between the two terminal modules. The grounding terminals 20G of the two opposite terminal modules at two sides of the mating slot 11 are mechanically connected by the attached portion 34 and the grounding portion 31 respectively.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing comprising two longitudinal side walls and a mating slot between the two side walls;
two terminal modules retained in the insulating housing, each terminal module comprising an insulator and a row of terminals retained in the insulator, each row of terminals comprising plural pairs of signal terminals and plural grounding terminals in a longitudinal direction, each terminal comprising a fixing portion fixed in the insulator, an elastic arm with an arc contacting portion extending into the mating slot, and a tail portion; and
two grounding members each being attached to a corresponding insulator and located between the corresponding insulator and a corresponding side wall;
wherein the grounding member comprises plural shielding portions, plural grounding portions, plural bridge portions, and plural attached portions, the grounding portions contact corresponding grounding terminals and the shielding portions face and shield corresponding pairs of signal terminals, every two adjacent shielding portions are integrally connected by a corresponding bridge portion, the grounding portion bends inwardly from the bridge portion, and the attached portion bends outwardly from the bridge portion.

2. The electrical connector as claimed in claim 1, wherein the attached portions and the grounding portions are parallel to corresponding bridge portions.

3. The electrical connector as claimed in claim 2, wherein the grounding portion extends downwards from an upper edge of a corresponding bridge portion, and the attached portion extends upwards from a lower edge of a corresponding bridge portion.

4. The electrical connector as claimed in claim 1, wherein upper edges of the shielding portions are located proximate to lower edges of the contacting portions of the signal terminals.

5. The electrical connector as claimed in claim 1, wherein the side walls have plural first slots and second slots running therethrough in a transverse direction perpendicular to the side walls, the contacting portions of each pair of signal terminals are exposed to a corresponding first slot and the contacting portion of each grounding terminal is exposed to a corresponding second slot.

6. The electrical connector as claimed in claim 5, wherein the shielding portions extend upward to corresponding first slots.

7. The electrical connector as claimed in claim 1, wherein the shielding portion has a vertical slot, the insulator has plural receiving grooves at an outside thereof and plural convex portions protruding relative to the receiving grooves, the grounding member is received in the receiving grooves, and the convex portions are received and retained in corresponding vertical slots.

8. The electrical connector as claimed in claim 7, wherein a first notch goes through the convex portion in the transverse direction to expose a corresponding pair of signal terminals.

9. The electrical connector as claimed in claim 7, wherein a second notch goes through the receiving groove and the grounding portions go through corresponding second notches to contact with corresponding grounding terminals.

10. An electrical connector comprising:
a longitudinal insulating housing comprising two side walls and a mating slot between the two side walls, the mating slot defining a mating opening; and
two rows of terminals located at the two side walls, each row of terminals comprising plural pairs of signal terminals and plural grounding terminals, each terminal comprising an elastic arm with a contacting portion protruding into the mating slot and proximate to the mating opening, a tail portion, and a middle fixing portion between the elastic arm and the tail portion;
wherein the side wall has plural first slots and plural second slots proximate to the mating opening, the contacting portions of each pair of signal terminals are exposed to a corresponding first slot, and the contacting portion of each grounding terminal is exposed to a corresponding second slot.

11. The electrical connector as claimed in claim 10, further comprising a grounding member, wherein the grounding member comprises plural grounding portions and plural shielding portions contacting with the grounding terminals, the shielding portions face corresponding pairs of signal terminals and extend upward to corresponding first slots.

12. The electrical connector as claimed in claim 11, wherein the grounding member comprise plural bridge portions each integrally connected between two adjacent shielding portions, and the grounding portion bends inwardly from the bridge portion.

13. The electrical connector as claimed in claim 12, wherein the grounding member comprises an attached portion bending outwardly from the bridge portion, and the attached portion is parallel to the bridge portion.

14. An electrical connector comprising:
an insulating housing having two side walls and a longitudinal mating slot between the two side walls;
a row of terminals located at the side wall and comprising plural pairs of signal terminals and plural grounding terminals in a longitudinal direction, each terminal comprising an elastic arm with a contacting portion, a tail portion and a middle fixing portion between the elastic arm and the tail portion; and
a grounding member located between the side wall and the row of the terminals and extending in the longitudinal direction;
wherein the grounding member comprises plural grounding portions extending inwards and contacting corresponding grounding terminals and plural attached portions extending outwards, and the attached portions are aligned with corresponding grounding portions in a transverse direction perpendicular to the side walls.

15. The electrical connector as claimed in claim 14, wherein the grounding portions and the attached portions are disposed parallel to each other.
